(19) United States
(12) Patent Application Publication
(10) Pub. No.: US 2008/0129471 A1
(43) Pub. Date: Jun. 5, 2008

(54) Motor Vehicle Comprising A Display Arrangement For Displaying Information Relating To The Operation Of The Motor Vehicle

(76) Inventors: Arne Stoschek, Palo Alto, CA (US); Brian Ng, San Jose, CA (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/566,299

(22) Filed: Dec. 4, 2006

(51) Int. Cl. B60Q 1/00; B62D 25/14

(52) U.S. Cl. 340/425.5; 296/70

(57) ABSTRACT

A motor vehicle has a display arrangement for displaying information relating to the operation of the motor vehicle, the display arrangement comprising a first display for optically representing information and at least one second display for optically representing information, the second display being arranged above the first display and being transparent so that information represented on the first display can be seen through the second display.

### TECHNICAL FIELD

The invention relates to a motor vehicle comprising a display arrangement for displaying information relating to the operation of the motor vehicle.

### BACKGROUND

The increasing functionalities of a motor vehicle result in the problem of configuring displays and operating elements for different functions in such a way that the driver of a motor vehicle can recognize and operate them with particular ease.

Various solutions of this problem are known from the prior art. Thus, e.g., provision has been made according to EO 00/21795 to design a display field in several parts, one part of the display field representing an information panel on which is presented information pertaining to the selected menu or selected function and optionally, important information pertaining to other function groups. Function and/or status displays are generated clearly on the remaining part of the display field in such a way that they are each assigned to an operating element—preferably to the operating element, to which the respective function for operation is assigned in this selection menu.

### SUMMARY

It is the object of the invention to create a display arrangement, which is particularly well-suited for motor vehicles and/or to further improve the operation of a motor vehicle.

The aforementioned task is solved by a motor vehicle having a display arrangement for displaying information relating to the operation of the motor vehicle, said display arrangement comprising a first display for optically representing information and at least one second display for optically representing information, said second display being arranged above the first display and being transparent so that information represented on the first display can be seen through the second display. Additional transparent displays can be provided between the first and the second display.

A display within the meaning of the invention is particularly a display or a matrix display for the variable representation of information. A first display within the meaning of the invention can be e.g., a TFT.

In a design form of the invention, a distance between the first display and the second display is variable.

In another design form of the invention, the display arrangement comprises a control unit for controlling the second display in such a way that an operating element or a warning message can be represented by means of the second display.

In another design form of the invention, the display arrangement comprises at least one third display for optically representing information, said third display being arranged above the second display and being transparent so that both information represented on the first display as well as information represented on the second display can be seen through the third display.

In another design form of the invention a distance between the second display and the third display is variable.

In another design form of the invention, the display arrangement comprises a control unit for controlling the third display in such a way that an operating element or a warning message can be represented by means of the third display.

In another design form of the invention, information to be represented by means of the display arrangement is assigned a value, wherein the selection as to whether the information is represented by means of the first or the second display or the third or an additional display takes place as a function of the value.

In another design form of the invention, the display arrangement comprises a navigation system for determining and displaying the current position of the motor vehicle, wherein a map extract can be represented by means of the first display.

In another design form of the invention, the current position of the motor vehicle can be represented by means of the first display.

In another design form of the invention, the current position of the motor vehicle can be represented by means of the second display in such a way that when the display arrangement is observed as intended, said position hides the region of a map extract, which is represented on the first display and which corresponds to the current position of the motor vehicle in the map extract.

In another design form of the invention, a direction indication can be represented by means of the second display.

Provision can also be made for using one of the displays, particularly the second display for displaying alternative input functions, such as e.g., voice recognition or gesture recognition.

In another design form of the invention, the surroundings of the motor vehicle, especially a blind spot or a rear view can be represented by means of the display arrangement. Information related to infotainment, service or climate control could be displayed by means of the display arrangement.

The aforementioned object is further attained by a method for operating a motor vehicle, which comprises especially one or more of the aforementioned features and which comprises a display arrangement for displaying information relating to the operation of the motor vehicle, said display arrangement comprising a first display for optically representing information and at least one second display for optically representing information, said second display being arranged above the first display, wherein an operating element and/or a warning message is represented by means of the second display.

Another invention or design form relates to a diagnosis system comprising a display arrangement, which comprises especially one or more of the aforementioned features and which comprises a first display for optically representing information, at least one second display for optically representing information, said second display being arranged above the first display, and a control unit for controlling the first and the second displays in such a way that diagnosis information can be represented by means of the first display and an explanation or an operating element can be represented by means of the second display.

For the implementation of a display arrangement according to the inventions, liquid crystal display (LCD), digital light processing (DLP), light-emitting diode-based (LED-based), organic light emitting diode (OLED), transparent OLED, or liquid crystal on silicon (LCoS) technologies may be used.

A motor vehicle within the meaning of the inventions is especially a land vehicle, which can be used individually in road traffic. Motor vehicles within the meaning of the invention are especially not limited to land vehicles having an internal combustion engine.

### BRIEF DESCRIPTION OF THE DRAWINGS

Additional advantages and details will become apparent from the following description of example embodiments.

FIG. 1 illustrates an interior view of an example embodiment of a motor vehicle;

FIG. 2 is a schematic diagram of an example embodiment of a display arrangement;

FIG. 3 illustrates a perspective lateral view of the display arrangement shown in FIG. 2; and

FIG. 4 illustrates a perspective lateral view of the display arrangement shown in FIG. 2.

### DETAILED DESCRIPTION

FIG. 1 illustrates an internal view of an example embodiment of a motor vehicle 1. A steering wheel 2 is arranged below a dashboard 3 in the motor vehicle 1. The dashboard 3 comprises a display arrangement 4 arranged adjacent to the steering wheel 2. Alternatively or additionally, a display arrangement corresponding to the display arrangement 4 can also be arranged in the steering wheel 2. Alternatively, a display indicated by reference numeral 5 can also be designed correspondingly to the display arrangement 4.

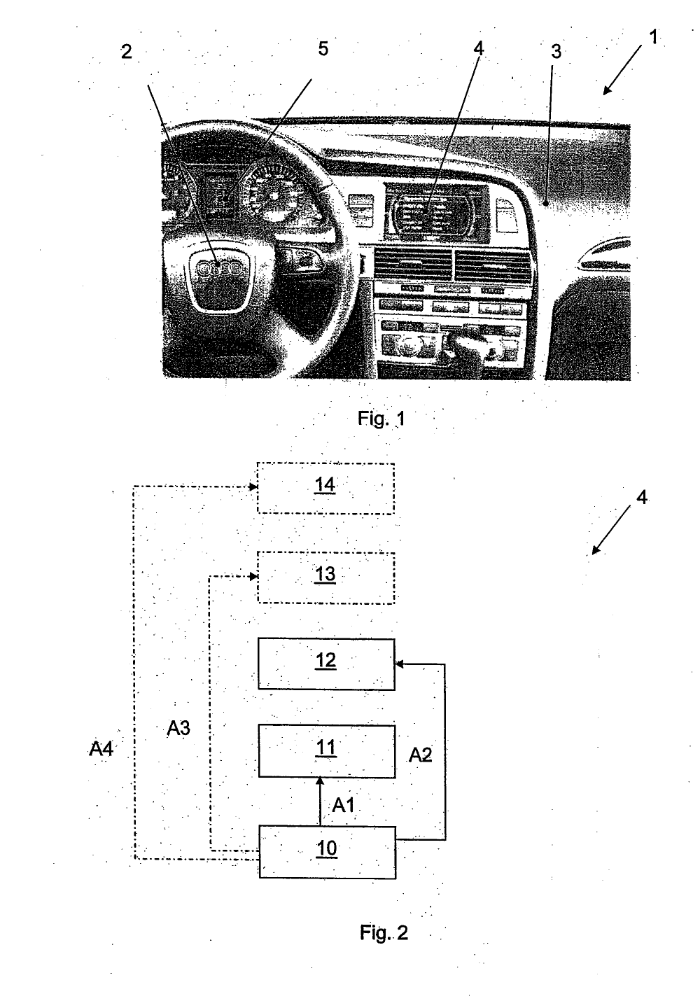

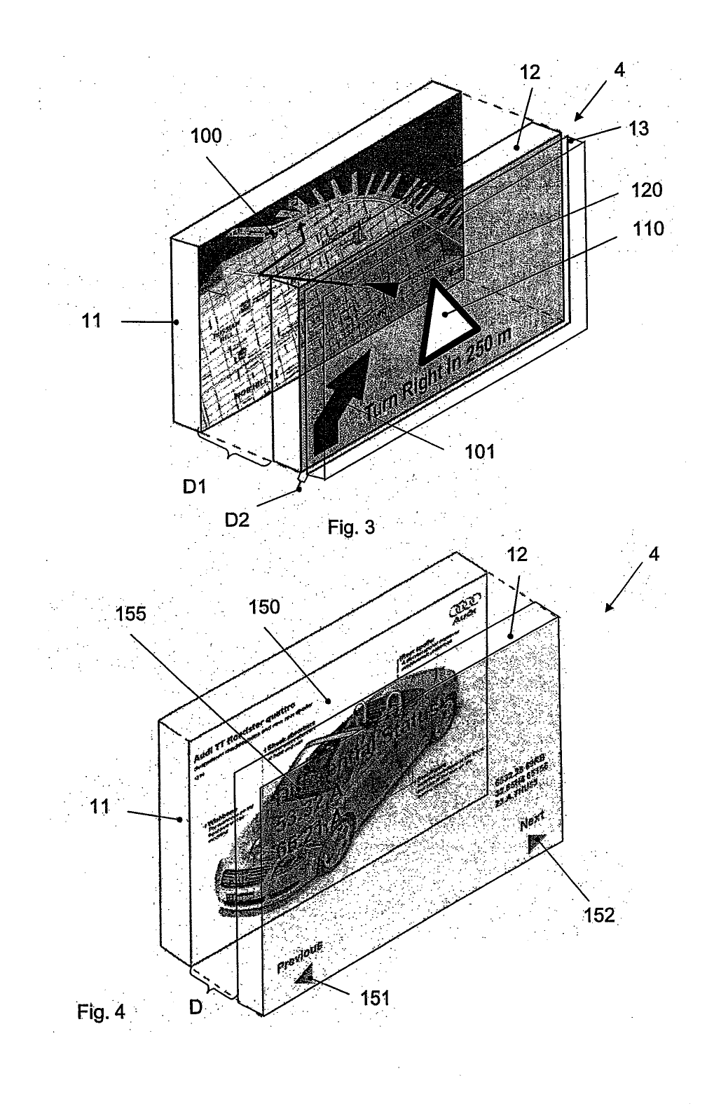

FIG. 2 is a schematic diagram of the display arrangement 4. FIG. 3 and FIG. 4 illustrate a reduced perspective lateral view of the display arrangement 4. The display arrangement 4 comprises a display 11 for optically representing information and at least one additional substantially transparent display 12 for optically representing information, said second display being arranged above the display 11. Additional substantially transparent displays can also be provided between display 11 and display 12. An additional substantially transparent display 13 for optically representing information can also be provided above display 12. An additional substantially transparent display 14 for optically representing information can also be provided above display 13.

In the exemplary configuration illustrated in FIG. 3, the display arrangement 4 comprises a display 11 for optically representing information, a substantially transparent display 12 for optically representing information, said display 12 being arranged above display 11, and an additional substantially transparent display 13 for optically representing information, said display 13 being arranged above display 12. Provision can be made for the distance D1 between the display 11 and display 12 to be variable. Alternatively or additionally, provision can be made for the distance D2 between the display 12 and the display 13 to be variable.

In the exemplary configuration illustrated in FIG. 4, the display arrangement 4 comprises a display 11 for optically representing information and at least one substantially transparent display 12 for optically representing information, said display 12 being arranged above display 11. Provision can be made for the distance D between the display 11 and display 12 to be variable.

As illustrated in FIG. 2, the display arrangement 4 comprises a control unit 10, by means of which different information can be represented by producing corresponding display signals A1 and A2 on the displays 11 and 12. Furthermore, different information can be represented by means of the control unit 10 by producing corresponding display signals A3 and A4 on displays 13 and 14, if corresponding displays are provided.

In the state illustrated in FIG. 3, the display arrangement 4 serves as a human-machine interface for a navigation system. For this purpose, a map extract 100 is represented by means of display 11 and a direction indication 101 is illustrated by means of display 12. A warning notice 110 is illustrated by means of display 13, if the latter is provided for a situation. Traffic signs and/or operating elements can also be represented by means of display 12 or display 13. Warnings can also be combined with an acoustic signal.

Reference numeral 120 indicates a marking for indicating the current position of the motor vehicle. The marking 120 can be displayed e.g., by means of display 11 or display 12. If the marking 120 is displayed by means of display 12, this takes place in such a way that when the display arrangement 4 is observed as intended, the marking 120 hides the region of the map extract 100 represented on display 11, said region corresponding to the current position of the motor vehicle in the map extract 100.

In the state illustrated in FIG. 4, the display arrangement 4 serves as a human-machine interface for a diagnosis system. For this purpose, diagnosis information 150 is represented by means of display 11, and operating elements or references 151, 152 to operating elements (not illustrated in FIG. 4) arranged at the edge of the display arrangement 4 are represented by means of display 12. The diagnosis information 150 displayed by means of display 11 can be changed by operating said operating elements. Provision can also be made for representing details or explanations 155 of the diagnosis information 150 by means of display 12.

For the implementation of display arrangement 4, liquid crystal display (LCD), digital light processing (DLP), light-emitting diode-based (LED-based), organic light-emitting diode (OLED), transparent OLED, or liquid crystal on silicon (LCoS) technologies may be used.

In another design form of the display arrangement 4, a value is assigned to information represented by means of the display arrangement 4. The information in this design form is stored with its values in the control unit 10, and the selection as to whether the information is represented by means of display 11 or display 12 or by means of display 13 or display 14, if the latter are provided, takes place as a functions of this value. In this design form, a value can be assigned according to table 1 e.g., to the information represented in the example embodiment shown in FIG. 3.

TABLE 1

| Information | Value |
|---|---|
| Map extract | 3 |
| Marking | 2 |
| Direction indication | 2 |
| Warning notice | 1 |

### LIST OF REFERENCE NUMERALS

| | |
|---|---|
| 1 | Motor vehicle |
| 2 | Steering wheel |
| 3 | Dashboard |
| 4 | Display arrangement |
| 5 | Display |
| 10 | Control unit |
| 11, 12, 13, 14 | Display |
| 100 | Map extract |
| 101 | Direction indication |
| 110 | Warning notice |
| 120 | Marking |
| 150 | Diagnosis information |
| 151, 152 | Operating element or reference to an operating element |
| 155 | Details or explanations of diagnosis information |
| A1, A2, A3, A4 | Display signal |
| D, D1, D2 | Distance |

1. A motor vehicle comprising a display arrangement for displaying information relating to the operation of the motor vehicle, said display arrangement comprising:
a first display for optically representing information; and
at least a second display for optically representing information, said second display being arranged above the first display and being transparent so that information illustrated on the first display can be seen through the second display.

2. A motor vehicle according to claim 1, wherein a distance between the first display and the second display is variable.

3. A motor vehicle according to claim 1, the display arrangement further comprising:
a control unit for controlling the second display in such a way that an operating element or a warning message can be represented by means of the second display.

4. A motor vehicle according to claim 1, the display arrangement further comprising:
at least one third display for optically representing information, said third display being arranged above the second display and being transparent so that both information illustrated on the first display as well as information illustrated on the second display can be seen through the third display.

5. A motor vehicle according to claim 4, wherein a distance between the second display and the third display is variable.

6. A motor vehicle according to claim 4, the display arrangement further comprising:
a control unit for controlling the third display in such a way that an operating element or a warning message can be represented by means of the third display.

7. A motor vehicle according to claim 1, said motor vehicle further comprising:
a navigation system for determining and displaying the current position of the motor vehicle, wherein a map extract can be represented by means of the first display.

8. A motor vehicle according to claim 7, wherein the current position of the motor vehicle can be represented by means of the first display.

9. A motor vehicle according to claim 7, wherein the current position of the motor vehicle can be represented in such a way that when the display arrangement is observed as intended, said position hides the region of a map extract illustrated on the display, said region corresponding to the current position of the motor vehicle in the map extract.

10. A motor vehicle according to claim 7, wherein a direction indication can be represented by means of the second display.

11. A motor vehicle comprising
a dashboard with a display arrangement comprising:
a first display for optically representing information; and
at least a second display for optically representing information, said second display being arranged over the first display and being transparent in such a way that information illustrated on the first display can be seen through the second display.

12. A motor vehicle according to claim 11, wherein a distance between the first display and the second display is variable.

13. A motor vehicle according to claim 11, the display arrangement further comprising:
a control unit for controlling the second display in such a way that an operating element or a warning message can be represented by means of the second display.

14. A motor vehicle according to claim 11, the display arrangement further comprising:
at least one third display for optically representing information, said third display being arranged above the second display and being transparent so that both information illustrated on the first display as well as information illustrated on the second display can be seen through the third display.

15. A motor vehicle according to claim 14, wherein a distance between the second display and the third display is variable.

16. A motor vehicle according to claim 14, the display arrangement further comprising:
a control unit for controlling the third display in such a way that an operating element or a warning message can be represented by means of the third display.

17. A motor vehicle according to claim 11, said motor vehicle further comprising:
a navigation system for determining and displaying the current position of the motor vehicle, wherein a map extract can be represented by means of the first display.

18. A motor vehicle according to claim 17, wherein the current position of the motor vehicle can be represented by means of the first display.

19. A motor vehicle according to claim 17, wherein the current position of the motor vehicle can be represented in such a way that when the display arrangement is observed as intended, said position hides the region of a map extract illustrated on the display, said region corresponding to the current position of the motor vehicle in the map extract.

20. A motor vehicle according to claim 17, wherein a direction indication can be represented by means of the second display.
